(19) United States
(12) Patent Application Publication
(10) Pub. No.: US 2024/0282222 A1
(43) Pub. Date: Aug. 22, 2024

(54) A RECYCLABLE ARTICLE FOR PACKAGING

(71) Applicant: Conopco, Inc., d/b/a UNILEVER, Englewood Cliffs, NJ (US)

(72) Inventors: Artur Traldi BEZERRA, Liverpool (GB); Yuvesveri NAIDOO, Wirral (GB)

(21) Appl. No.: 18/681,797

(22) PCT Filed: Aug. 30, 2022
(86) PCT No.: PCT/EP2022/074119

§ 371 Date: Feb. 6, 2024

(30) Foreign Application Priority Data
Sep. 15, 2021 (EP) 21197005.8

(51) Int. Cl. G09F 3/02; B65D 23/08; B65D 25/36

(52) U.S. Cl. CPC G09F 3/02; B65D 23/085; B65D 25/36; G09F 2003/0223; G09F 2003/023; G09F 2003/0273

(57) ABSTRACT

A sustainable, recyclable article includes a container and a label. The container is composed of a first polymer, the first polymer being recyclable. The label is fixed to the container using a recyclable clear permanent acrylic adhesive. The label includes a substrate layer composed of a second polymer. The second polymer is different from the first polymer. The label covers at least 70% of a total area of the container The substrate layer has a thickness of 40 μm to less than 60 μm.

### FIELD OF THE INVENTION

The present invention relates to a sustainable, recyclable article for packaging; in particular it relates to a recyclable article that has a maximum label coverage.

### BACKGROUND OF THE INVENTION

Across the world, plastic has become an integral part of people's lives, but with it has also emerged the growing problem of its waste. Plastics are useful and versatile materials of low cost and are convenient to use. It is not the use of plastic that is the problem but the single use of it is. By a single use of plastic, 95% of its value is lost.

Plastic packaging uses nearly 40% of all polymers, a substantial share of which is used for consumer products, such as personal care packages (e.g., shampoo, conditioner, liquid hand wash) and household packages (e.g., for laundry detergent and cleaning compositions).

However, recent years have witnessed a substantial effort to recycle plastic packaging. Plastic packaging that has been collected via established consumer recycling streams, sorted, washed and reprocessed into pellets is defined as post-consumer resin (PCR). This can be used instead of virgin resin to create new plastic packaging for consumer goods.

Current plastic packaging can face difficulties during recycling. In the first few steps of typical recycling procedure, a commonly used sorting process is by automatic near infrared (NIR) which separates plastic into different polymer streams for reprocessing into PCR. When automatic near infrared (NIR) sorting systems which are used predominantly in material recovery facilities (MRFs), plastics recovery facilities (PRFs) and at reprocessors cannot detect and sort the polymers into the correct polymer stream, this causes difficulties during recycling.

There can be various reasons why the polymers are not sorted into the correct polymer stream, one of which is when the label covering the plastic article is of a different polymer than that of the article, it does not allow detection of the polymer of the article, thereby sorting the article into the wrong polymer stream. This is a problem when most of the plastic article is covered with the label. This problem is known to be solved by reducing the coverage of the label however, reduced area of the label would mean reduced provision of product information to the consumer. Hence, reduced label coverage is not desirable.

A need therefore remains to have plastic packaging with maximum label coverage on the container, while being able to recycle without causing difficulties during recycling.

It is therefore an object of the present invention to provide a plastic packaging which can be recycled.

It is another object of the present invention to provide a capture rate of more than 85% during recycling for a plastic packaging having more than or equal to 70% label coverage.

It is yet another object of the present invention to provide plastic packaging having more than or equal to 70% label coverage which can be recycled.

It is yet another object of the present invention to provide a plastic packaging wherein the polymer of plastic article can be detected and sorted by NIR (near infrared) sorting process.

Surprisingly it has been found that the polymer of the plastic packaging with a higher label coverage can be detected and sorted by NIR (near infrared) sorting process by maintaining a thickness of less than 60 μm in the substrate layer of the label used.

### SUMMARY OF THE INVENTION

Accordingly, in a first aspect, the present invention provides a sustainable, recyclable article comprising a container composed of a recyclable polymer; and a label comprising a substrate layer composed of a different polymer than that of the container and said label covering at least 70% of the total area of the container; wherein the substrate layer has a thickness of 40 μm to less than 60 μm.

In a second aspect, the present invention provides use of a sustainable, recyclable article comprising a container composed of a recyclable polymer; a label comprising a substrate layer composed of a polymer and said label covering at least 70% of the total area of the container; wherein the substrate layer has a thickness of 40 μm to less than 60 μm for identification and sorting by NIR sortation equipment.

In the context of the present invention, the reference to “sustainable” typically means a material having an improvement of greater than 10% in some aspect of its Life Cycle Assessment or Life Cycle Inventory, when compared to the relevant virgin petroleum-based plastic material that would otherwise have been used to manufacture the article. As used herein, “Life Cycle Assessment” (LCA) or “Life Cycle Inventory” (LCI) refers to the investigation and evaluation of the environmental impacts of a given product or service caused or necessitated by its existence. The LCA or LCI can involve a “cradle-to-grave” analysis, which refers to the full Life Cycle Assessment or Life Cycle Inventory from manufacture (“cradle”) to use phase and disposal phase (“grave”). For example, high density polyethylene (HDPE) containers can be recycled into HDPE resin pellets, and then used to form containers, films, or injection molded articles, for example, saving a significant amount of fossil-fuel energy. At the end of its life, the polyethylene can be disposed of by incineration, for example. All inputs and outputs are considered for all the phases of the life cycle.

In the context of the present invention, the reference to “recyclable” typically means the ability of the components of an article (e.g. bottle, cap, labels) to enter into current recycling streams established for petroleum-derived resins (e.g. HDPE, PET, PP) or paper without compromising the suitability of recycled resin or paper output for use in remaking components.

These and other aspects, features and advantages will become apparent to those of ordinary skill in the art from a reading of the following detailed description and the appended claims. For the avoidance of doubt, any feature of one aspect of the present invention may be utilised in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Similarly, all percentages are weight/weight percentages unless otherwise indicated. Except in the operating and comparative examples, or where otherwise explicitly indicated, all numbers in this description indicating amounts of material or conditions of reaction, physical properties of materials and/or use are to be understood as modified by the word “about”.

Numerical ranges expressed in the format “from x to y” are understood to include x and y. When for a specific feature multiple preferred ranges are described in the format “from x to y”, it is understood that all ranges combining the different endpoints are also contemplated.

### DETAILED DESCRIPTION OF THE INVENTION

In a first aspect, the present invention relates to a sustainable, recyclable article comprising a container; and a label covering at least 70% of the total area of the container.

The article according to the invention is a packaging for fast moving consumer goods (FMCG), such as personal care products, beauty products, cosmetic products, home care products and/or food products.

### Container

The container of the present invention is composed of a recyclable polymer selected from the group consisting of virgin polyethylene; post-consumer recycled polyethylene (PCR-PE); post-industrial recycled polyethylene (PIR-PE); and a mixture thereof. The polyethylene can include HDPE (high-density polyethylene) or a mixture of HDPE (high-density polyethylene) and LDPE (low density polyethylene). In alternative embodiments, the polymer is selected from the group consisting of virgin polyethylene terephthalate; post-consumer recycled polyethylene terephthalate (PCR-PET); post-industrial recycled polyethylene terephthalate (PIR-PET); and a mixture thereof. In other alternative embodiments, the polymer is selected from the group consisting of polypropylene; post-consumer recycled polypropylene (PCR-PP); post-industrial recycled polypropylene (PIR-PP); and a mixture thereof.

Preferably, the container is composed of post-consumer recycled polyethylene terephthalate (PCR-PET), post-consumer recycled polypropylene (PCR-PP) or post-consumer recycled polyethylene (PCR-PE).

The container is preferably a bottle for packaging fast moving consumer goods (FMCG), such as personal care products, beauty products, cosmetic products, home care products and/or food products.

### Label

The label is composed of a substrate layer that includes a polymer selected from the group consisting of polyethylene; post-consumer recycled polyethylene (PCR-PE); post-industrial recycled polyethylene (PIR-PE); paper; and a mixture thereof. The polyethylene can include LDPE (low density polyethylene), LLDPE, or HDPE (high-density polyethylene). In alternative embodiments, the substrate layer includes a polymer selected from the group consisting of polyethylene terephthalate; post-consumer recycled polyethylene terephthalate (PCR-PET); post-industrial recycled polyethylene terephthalate (PIR-PET); a polyester of furan dicarboxylic acid; a post-consumer recycled polyester of furan dicarboxylic acid; a post-industrial recycled polyester of furan dicarboxylic acid; a regrind polyester of furan dicarboxylic acid; paper; and a mixture thereof. In other alternative embodiments, the substrate layer includes a polymer selected from the group consisting of polypropylene; post-consumer recycled polypropylene (PCR-PP); post-industrial recycled polypropylene (PIR-PP); paper; and a mixture thereof.

The polymer may be uniaxially oriented (machine direction) (MDO) or biaxially oriented (BO).

Preferably the polymer is a biaxially oriented polypropylene (BOPP).

The label according to the invention covers at least 70%, preferably at least 80% of the total area of the container.

The label coverage can be assessed by calculating the ratio of “height of label”/“height of bottle” if the label is a full wrap around the bottle. It can also be assessed by calculating the ratio of the “label area”/“bottle area” for other kinds of labels for example; front and back labels.

The thickness of the substrate layer is critical. When the label covers most of the container, which equals to 70% or more of the total area on the container, the thickness of the substrate layer is between 40 μm to less than 60 μm to allow the NIR sortation equipment to accurately identify and sort the article. Preferably, the thickness of the substrate layer is at least 43 μm, more preferably at least 45 μm, still more preferably at least 48 μm, even more preferably at least 51 μm but typically not more than 59 μm, preferably not more than 57 μm, more preferably not more than 55 μm, even more preferably not more than 53 μm or even 52 μm.

Substrate layer thickness of less than 40 μm leads to problems during application with the adhesive, such as bubbling and creasing on the label.

The label further includes ink, which can be solvent-based or water-based. In some embodiments, the ink is derived from a renewable resource, such as soy, a plant, or a mixture thereof. The ink can be cured using heat or ultraviolet radiation (UV).

The thickness of the ink layer may vary between 2 to 14 μm depending on the print configuration.

The label can be fixed to the container using adhesive. In some embodiments, the adhesive is a recyclable adhesive, such as Fasson® SR3010—CleanFlake Adhesive Technology which is a clear, permanent acrylic adhesive, designed to enable PET bottle and thermoform container recycling per the Association of Plastic Recyclers (APR) Design Guide for Plastics Recyclability.

### Cap

The article according to the invention can further comprise a cap. In some embodiments, the cap of the invention is composed of a polymer selected from the group consisting of virgin polypropylene; post-consumer recycled polypropylene (PCR-PP); post-industrial recycled polypropylene (PIR-PP); and a mixture thereof. In some embodiments, the cap is composed of a polymer selected from the group consisting of linear low-density polyethylene (LLDPE); post-consumer recycled LLDPE; post-industrial recycled LLDPE; high density polyethylene (HDPE); post-consumer recycled polyethylene (PCR-PE); post-industrial recycled polyethylene (PIR-PE); and a mixture thereof. For example, the cap can be composed of (i) a polymer selected from the group consisting of linear low density polyethylene (LLDPE), as described above; post-consumer recycled LLDPE; post-industrial recycled LLDPE, and a mixture thereof; or (ii) a polymer selected from the group consisting of high density polyethylene (HDPE), as described above; post-consumer recycled HDPE; post-industrial recycled polyethylene HDPE; low density polyethylene (LDPE); post-consumer recycled LDPE; post-industrial recycled LDPE; and a mixture thereof.

### Use

In a second aspect, the present invention relates to use of a sustainable, recyclable article comprising a container composed of a recyclable polymer; a label comprising a substrate layer composed of a polymer and said label covering at least 70% of the total area of the container; wherein the substrate layer has a thickness of 40 μm to less than 60 μm for identification and sorting by NIR sortation equipment.

The invention will now be further described by reference to the following non-limiting examples. In the examples, all percentages are by weight based on total weight, unless otherwise specified.

### EXAMPLES

### Example 1: Sorting Potential of a Whole Plastic Article

In this example plastic articles with different label thicknesses were evaluated on whether they can be accurately identified and sorted on pilot scale NIR sortation equipment that performs similarly to that used in production facilities.

The test is one in the series of “Sorting Potential Test Methods” developed by the Association of Plastics Recyclers (APR).

(Title: Evaluation of the Near Infrared (NIR) Sorting Potential of a Whole Plastic Article; Document Number: Sort-B-01: Publication or Revision Date: May 15, 2018).

### Test Method

The sorting potential test methods describe laboratory-scale representations of the most commonly used collection and Material Recovery Facility (MRF) processes for handling single-stream post-consumer recyclables. The test methods assume that these co-mingled recyclables are collected curbside, compacted in a typical recycling collection truck, transported to and processed through an automated MRF into bales of similar plastics, then further processed at the plastics reclaimer in their original form before being reduced in size.

These tests do not consider the plastics recycling process starting from or after size reduction at the plastics reclaimer. Nor do they represent other processes that may use different methods of collection and separation with different results. Furthermore, plastic sorting processes have some degree of variability in commercial practice. It is not the intent of this protocol to model every possible process outcome but to choose a common set of parameters widely employed and which fall squarely within those used in industry.

The sorting potential tests are intended to identify specific design features that may cause an entire package to be lost in the recycling process. The consequences of a plastic article being mis-sorted prior to size reduction are more significant than in processes that follow size reduction, since the entire package is lost to the plastics recycling stream rather than a mere component of the package. The modelling of sorting behaviour in this test enables design engineers to focus their improvement efforts and is designed to complement the wide range of tests offered by APR that form the foundation of APR's Design Guidance for plastic package recyclability.

Typically, today's newer single stream MRFs and PET reclaimers employ automated equipment that sort plastic packaging and other items by their NIR (near infrared) signature, either in transmission or reflection. For this equipment to operate effectively it must accurately identify the plastic article and direct it to the correct location.

Otherwise, the article is either directed to the waste stream or becomes a contaminant in another recyclable stream where it is likely to not be recycled.

This specific NIR sorting potential test method provides a means of evaluating whether a plastic article can be accurately identified and sorted on pilot scale NIR sortation equipment that performs similarly to that used in production facilities. Good results in this screening test indicate that a plastic article has the potential to be sorted well in production conditions. Poor results indicate that an improvement in plastic product design is desirable to promote recovery. An optional, second part of this test method incorporates a means of determining whether the pilot equipment & software has the ability to be adjusted to correctly identify and sort this article and if so, to capture this adjustment in production facilities.

The test involves establishing the baseline performance of a pilot NIR sorting machine by processing a known blend of material while targeting the polymer of the test article. Then, 20 samples of the test article are added, and the mix is reprocessed. Sorting efficiency of the test articles is compared to the baseline efficiency. Five passes through the NIR unit are used to develop repeat values for the test article.

### Equipment Required:

1. Bottle compression device built per the instructions found at https://plasticsrecycling.org/images/pdf/design-guide/test-methods/Compression Practice for Sorting.pdf
2. Binary NIR bottle sorter operating in representative (reflective or transmissive) mode of typical field equipment, with applicable feed belt and discharge chutes. This test is conducted on pilot plant scale NIR sortation equipment. Please refer to “APR Recognized Laboratories for Testing” found at https://plasticsrecycling.org/images/pdf/design-guide/Resources/Candidate Test Labs.pdf for a list of potential test locations.

### Materials Required:

1. 20 identical candidate test articles provided by the test applicant. These articles should be fully decorated i.e. with label, closures, etc. as if they were placed in a curbside bin after consumer use. Note that these articles are empty whereas some residual product may remain in the articles found in the actual recycling stream. Sorting machines are generally programmed to minimize the effects of common amounts of residual product so this test does not consider residual product.
2. Mix of plastic articles representing the plastic material commonly processed through a container line at a MRF. This mix should be of sufficient quantity to operate the trial sorting machine at 50% nameplate throughput or greater for at least 1 minute (a general rule of thumb for nameplate capacity is 1 ton/hr per meter of machine width which equates to 34 lbs per minute or approximately 733 bottles per minute but this ratio is dependent on manufacturer). These articles are normally provided and maintained by the test lab, should be previously compressed through the actual collection system and include labels and attachments. By weight percent the mix should consist of:
   7-12% Polypropylene containers between 8 oz. and 2 liters
   12-17% HDPE natural containers between 8 oz. and 1 gallon
   16-21% HDPE colored containers between 8 oz. and 1 gallon
   45-50% PET containers between 8 oz. and 2 liters, ensuring that at least 20 of the following are represented:
      clear or light blue single serve water
      clear 2 liter carbonated soft drink
      green 2 liter carbonated soft drink
      clear with shrink sleeve label less than 75% label coverage
   2-3% PETG containers—10-15% Other plastic containers, insuring that PS, PVC and black items are represented

### Method Steps:

1. Take pictures of all articles for submission including:
a. One candidate test article before compression
b. All candidate test articles after compression (one collective picture)
c. The mix of other articles (one collective picture)

2. Compress the candidate articles according to the APR compression practice found at: https://plasticsrecycling.org/images/pdf/design-guide/test-methods/Compression Practice for Sorting.pdf

Compression helps flatten the articles, making them less likely to slide on the conveyor belt. Successful optical sorting requires articles to remain stable on the conveyor belt so the ejector can be timed with the sensor. Sorting tests performed on rounded items that are not compressed may have poor results.

3. The material mix was collected and classified (it is anticipated that the testing lab maintains this mix in its facility for use as required and the classification has already been completed):
a. Complete the attached form classifying the mix with the weight and count of each article type.
b. Ensure the mix is of sufficient size to feed the sorter at 50% rated throughput or greater for at least 1 minute. It is permissible and expected to adjust the usable width of the sorter to fall within these parameters.

4. Establish the baseline:
a. Set ALL sorter parameters to represent the typical machines installed in the field.
   i. For a candidate article primarily made from PET these parameters should represent the settings at a PET reclaimer since these machines typically represent the most stringent criteria in the process.
   ii. For a candidate article primarily made from PP or HDPE these parameters should represent the settings at a MRF since they are typically the only automatic sorters in the recycling process.
b. Using the manufacturers operating procedure, set the sorter to positively sort the polymer which represents the candidate article. DO NOT USE THE TEST ARTICLE TO ADJUST THE SETTINGS. Note: The purpose of this test is to represent the performance of the machines in the field, not the capabilities of the latest machine version. Therefore, this test is not an appropriate brand-to-brand or machine-to-machine comparison.
c. Blend the material mix without the candidate articles in a container so they are randomly mixed.
d. Meter the mixed articles onto the accelerating belt (or vibratory feeder—depending on test facility) at a rate at least 50% of the sorters nameplate throughput.
e. Record the number and percent of the target polymer articles correctly/positively sorted on the form below.

5. Test the candidate article.
a. To the material mix, reintroduce the items positively sorted from the baseline sort.
b. Add the candidate articles to the material mix and blend in a container so they are randomly mixed.
c. Meter the mixed articles onto the accelerating belt (or vibratory feeder—depending on test facility) at a rate at least 50% of the sorters nameplate throughput.
d. Record the number of candidate articles positively sorted on the form below.
e. Repeat 5 times

Measurements: For each run, record the count of the “positively” ejected test articles per the report form.

### Assessment:

Variance=The difference between the sorting efficiency of the test polymer established in the baseline test, minus the sorting efficiency of the test article in aggregate of the following tests

Capture rate=The percentage of test articles correctly sorted in the aggregate of the tests.

### If:

Variance is <=5%: The candidate article is most likely to be sorted correctly by NIR and the APR Design Guidance category for the design feature of “optical sorting potential” is preferred

Variance is >5% and Capture rate is >=51% A high percentage of the test articles will be missorted by NIR, but will most likely get sorted into the appropriate bale. The APR Design Guidance category for the design feature “optical sorting potential” is detrimental

Capture rate % is <51%: The candidate article will most likely be missorted by NIR and therefore the APR Design Guidance category for the design feature “optical sorting potential” is renders the package unrecyclable per the APR definition of recyclability

### Test Articles:

Bottles—made of 100% rPET
Caps—Polypropylene
Label substrate—BOPP (biaxially oriented polypropylene)

The test results are provided in the table below.

| | Thickness | | Label coverage | Capture rate | Variance |
|---|---|---|---|---|---|
| Ex 1 | 40 | microns | 80% | 95% | 0.02 |
| Ex 2 | 40 | microns | 70% | 94% | 0.03 |
| Ex 3 | 53 | microns | 80% | 94% | 0.03 |
| Ex 4 | 53 | microns | 70% | 89% | 0.05 |
| Ex 5 | 61 | microns | 80% | 75% | 0.18 |
| Ex 6 | 61 | microns | 70% | 63% | 0.34 |
| Ex 7 | 63.5 | microns | 70% | 76% | 0.21 |
| Ex 8 | 63.5 | microns | 60% | 94% | 0.03 |
| Ex 9 | 66 | microns | 80% | 54% | 0.45 |
| Ex 10 | 66 | microns | 70% | 57% | 0.42 |
| Ex 11 | 73 | microns | 80% | 50% | 0.50 |
| Ex 12 | 73 | microns | 70% | 75% | 0.22 |
| Ex 13 | 81 | microns | 70% | 78% | 0.19 |
| Ex 14 | 81 | microns | 60% | 84% | 0.13 |

Baseline PET recovery 97%

It is inferred from the above table that if a label coverage of 70% or more is required the thickness of the label substrate have to be maintained according to the invention (40 μm to less than 60 μm) to have a variance of <=5% to be able to be accurately identified and sorted by the NIR sortation equipment.

1. A sustainable, recyclable article comprising:
a container composed of a first polymer, the first polymer being recyclable; and
a label fixed to the container using a recyclable clear permanent acrylic adhesive, the label comprising a substrate layer composed of a second polymer, the second polymer being different from the first polymer, and the label covering at least 70% of a total area of the container, the substrate layer having a thickness of 40 μm to less than 60 μm.

2. The article of claim 1, wherein the label covers at least 80% of the total area of the container.

3. The article of to claim 1, wherein the thickness is between 40 μm to 55 μm.

4. The article of claim 1, wherein the thickness is between 45 μm to 55 μm.

5. The article of claim 1, wherein the second polymer is uniaxially oriented (machine direction) (MOO) or biaxially oriented (BO).

6. The article of claim 1, wherein the article is a packaging for fast moving consumer goods (FMCG).

7. A sustainable, recyclable article comprising:
a container composed of a first polymer, the first polymer being recyclable;
a label fixed to the container using a recyclable clear permanent adhesive, the label comprising a substrate composed of a second polymer and the label covering at least 70% of a total area of the container, the substrate layer having a thickness of 40 μm to less than 60 μm for identification and sorting by new infrared (NIR) sortation equipment.

8. An article comprising:
a container composed of a first polymer, the container having a total area;
a recyclable adhesive; and
a label fixed to the container via the recyclable adhesive, the label composed of a substrate layer comprising a second polymer, the substrate layer having a thickness that is between 40 μm and 60 μm, inclusive, the label covering 70% or more of the total area, the second polymer being a biaxially oriented polypropylene.

9. The article of claim 8, wherein the first polymer is composed of at least one of: a virgin polyethylene, a post-consumer recycled polyethylene, or a post-industrial recycled polyethylene.

10. The article of claim 9, wherein the first polymer is composed of at least one of: a high-density polyethylene or a low-density polyethylene.

11. The article of claim 8, wherein the first polymer is composed of at least one of: a virgin polyethylene terephthalate, a post-consumer recycled polyethylene terephthalate, or a post-industrial recycled polyethylene terephthalate.

12. The article of claim 8, wherein the first polymer is composed of at least one of: a polypropylene, a post-consumer recycled polypropylene, or a post-industrial recycled polypropylene.

13. The article of claim 8, wherein the substrate layer further comprises a paper.

14. The article of claim 8, wherein the layer further comprises an ink layer.

15. The article of claim 8, wherein the thickness is between 51 and 59 μm, inclusive.

16. The article of claim 8, wherein the thickness is between 51 and 52 μm, inclusive.

17. The article of claim 8, further comprising a cap composed of polypropylene.

18. The article of claim 17, wherein the first polymer is a polyethylene terephthalate.

19. The article of claim 18, wherein the adhesive is a clear, permanent acrylic adhesive.

20. The article of claim 19, wherein the thickness is between 51 and 59 μm, inclusive.
